(19) United States
(12) Patent Application Publication
(10) Pub. No.: US 2026/0012219 A1
(43) Pub. Date: Jan. 8, 2026

(54) BLUETOOTH CONTROLLER DEVICE AND METHOD FOR EFFECTIVELY REDUCING ACI NOISE OF MULTIPLE BLUETOOTH CONTROLLERS

(71) Applicant: MEDIATEK INC., Hsinchu City (TW)

(72) Inventors: Chih-Ting Huang, Hsinchu City (TW); Hsien-Hsin Wu, Hsinchu City (TW)

(73) Assignee: MEDIATEK INC., Hsinchu City (TW)

(21) Appl. No.: 19/243,644

(22) Filed: Jun. 19, 2025

Related U.S. Application Data
(60) Provisional application No. 63/668,370, filed on Jul. 8, 2024.

(51) Int. Cl. H04B 1/40; H04W 4/80; H04W 72/0446; H04W 76/15; H04W 76/18

(52) U.S. Cl. CPC H04B 1/40; H04W 72/0446; H04W 76/15; H04W 76/18; H04W 4/80

(57) ABSTRACT

A method of a Bluetooth controller device includes: providing multiple Bluetooth controllers to use a same configuration setting of a link control protocol sent from the host device to respectively control the multiple Bluetooth radio circuits to transmit and receive Bluetooth packets, clocks of the multiple Bluetooth controllers being synchronized with each other; and configuring the multiple Bluetooth controllers as central roles respectively to negotiate with corresponding peer Bluetooth controllers, to be used as peripheral roles associated with the central roles, by respectively ignoring or rejecting at least request from the corresponding peer Bluetooth controllers, to make a packet transmission time of a first Bluetooth radio circuit in the multiple Bluetooth radio circuits be separated from a packet reception time of a second Bluetooth radio circuit in the multiple Bluetooth radio circuits.

### CROSS REFERENCE TO RELATED APPLICATIONS

This application claims the benefit of U.S. Provisional Application No. 63/668,370, filed on Jul. 8, 2024. The content of the application is incorporated herein by reference.

### BACKGROUND

Generally speaking, in recent years, the 2.4 GHz band has become increasingly congested. Co-Channel Interference (CCI) and Adjacent Channel Interference (ACI) have consistently been primary challenges for communication system designers. Under these circumstances, integrating two or even more Bluetooth radio circuits into a single integrated circuit will undoubtedly exacerbate the problems of CCI and ACI.

### SUMMARY

Therefore one of the objectives of the invention is to provide a Bluetooth controller device and corresponding method, to solve the above-mentioned problems.

According to the embodiments, a Bluetooth controller device is disclosed. The Bluetooth controller device is coupled to a host device through a host interface function communication interface and coupled to multiple Bluetooth radio circuits. The Bluetooth controller device comprises multiple Bluetooth controllers. The multiple Bluetooth controllers used are for using a same configuration setting of a link control protocol sent from the host device to respectively control the multiple Bluetooth radio circuits to transmit and receive Bluetooth packets, and the clocks of the multiple Bluetooth controllers are synchronized with each other. The multiple Bluetooth controllers used are as central roles respectively to negotiate with corresponding peer Bluetooth controllers, to be used as peripheral roles associated with the central roles, by respectively ignoring or rejecting at least request from the corresponding peer Bluetooth controllers to make a packet transmission time of a first Bluetooth radio circuit in the multiple Bluetooth radio circuits be separated from a packet reception time of a second Bluetooth radio circuit in the multiple Bluetooth radio circuits.

According to the embodiments, a method of a Bluetooth controller device is disclosed. The Bluetooth controller device is to be coupled to a host device through a host interface function communication interface and coupled to multiple Bluetooth radio circuits. The method comprises: providing multiple Bluetooth controllers to use a same configuration setting of a link control protocol sent from the host device to respectively control the multiple Bluetooth radio circuits to transmit and receive Bluetooth packets, clocks of the multiple Bluetooth controllers being synchronized with each other; and, configuring the multiple Bluetooth controllers as central roles respectively to negotiate with corresponding peer Bluetooth controllers, to be used as peripheral roles associated with the central roles, by respectively ignoring or rejecting at least request from the corresponding peer Bluetooth controllers, to make a packet transmission time of a first Bluetooth radio circuit in the multiple Bluetooth radio circuits be separated from a packet reception time of a second Bluetooth radio circuit in the multiple Bluetooth radio circuits.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a Bluetooth controller device according to an embodiment of the invention.

FIG. 2 is a diagram showing a concept example of two Bluetooth radio circuits' (e.g. RF_0 and RF_1) transmissions and receptions based on the disclosed multiple Bluetooth coexistence approach according to an embodiment of the invention.

FIG. 3 is a diagram showing an example of synchronizing the time reference points respectively used by the Bluetooth controllers according to an embodiment of the invention.

FIG. 4 is a diagram showing an example of the Bluetooth controller (used as a central/master role) setting and negotiating parameter(s) of the link control protocol with a peer Bluetooth controller (used as a peripheral/slave role) according to an embodiment of the invention.

FIG. 5 is a diagram of the Bluetooth controllers forcing the fixed payload length between the Bluetooth controllers and their peer-side Bluetooth controllers as the same length according to an embodiment of the invention.

FIG. 6 is a diagram of the Bluetooth controllers forcing the fixed payload length between the Bluetooth controllers and their peer-side Bluetooth controllers as the same length and forcing only one pair of transmission and reception according to an embodiment of the invention.

FIG. 7 is a diagram of the Bluetooth controllers forcing only one pair of transmission and reception (TRX) between the Bluetooth controllers and their peer-side Bluetooth controllers and adjusting packet interval time lengths according to an embodiment of the invention.

### DETAILED DESCRIPTION

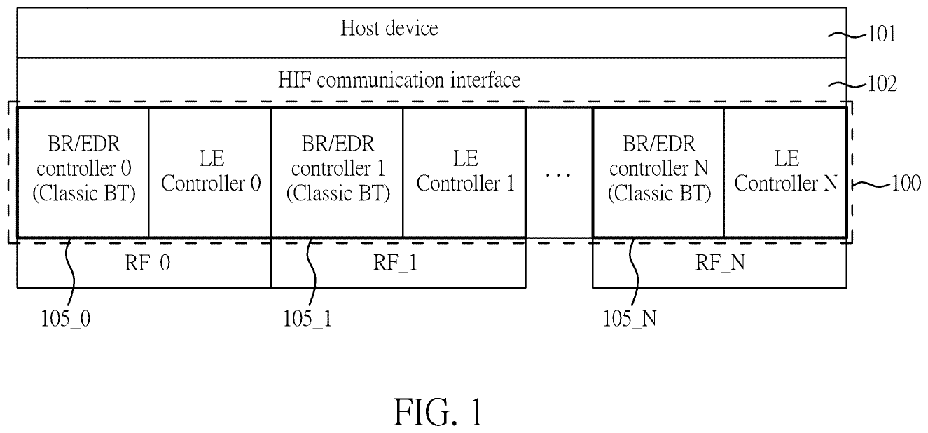

The invention aims at providing a Bluetooth controller device supporting a multiple Bluetooth coexistence approach. FIG. 1 is a diagram of a Bluetooth controller device 100 according to an embodiment of the invention. The Bluetooth controller device 100 is coupled to a host device 101 through a host interface function (HIF) communication interface 102 and coupled to multiple Bluetooth radio circuits such as RF_0, RF_1, . . . , and RF_N respectively. The Bluetooth controller device 100 comprises multiple Bluetooth controllers 105_0, 105_1, . . . , and 105_N respectively associated with and corresponding to the Bluetooth radio circuits such as RF_0, RF_1, . . . , and RF_N. The number of Bluetooth controllers is not intended to be a limitation of the invention. Each Bluetooth controller comprises a classic (BR/EDR) Bluetooth controller and an LE (low energy) controller. For example, the Bluetooth controller 105_0 comprises the classic (BR/EDR) Bluetooth controller having number 0 and the LE (low energy) controller having number 0. Similarly, the Bluetooth controller 105_1 comprises the classic (BR/EDR) Bluetooth controller having number 1 and the LE (low energy) controller having number 1, and the Bluetooth controller 105_N comprises the classic (BR/EDR) Bluetooth controller having number N and the LE (low energy) controller having number N. That is, each Bluetooth controller can support the functions and operations of a classic (BR/EDR) controller and the functions and operations of a low energy controller.

The multiple Bluetooth controllers 105_0, 105_1, . . . , and 105_N are used for using a same configuration setting of a link control protocol sent from the host device 101 to respectively control the multiple Bluetooth radio circuits RF_0, RF_1, . . . , and RF_N to transmit and receive Bluetooth packets. The clocks of the multiple Bluetooth controllers 105_0, 105_1, . . . , and 105_N are synchronized with each other.

In a protocol layer view, the multiple Bluetooth controllers 105_0, 105_1, . . . , and 105_N are used as central/master roles respectively to negotiate with corresponding peer Bluetooth controllers (not shown in FIG. 1), which are to be used as peripheral/slave roles associated with the central/master roles, by respectively ignoring or rejecting at least request from the corresponding peer Bluetooth controllers to make a packet transmission time of a first Bluetooth radio circuit (e.g. RF_0) scheduled by the first Bluetooth controller 105_0 be separated from a packet reception time of a second Bluetooth radio circuit (e.g. RF_1) scheduled by the second Bluetooth controller 105_1. It should be noted that, in this embodiment, the packet transmission time of the first Bluetooth radio circuit (e.g. RF_0) are separated from the packet reception time of the second Bluetooth radio circuit (e.g. RF_1) by the operations of the central roles (i.e. Bluetooth controllers 105_0, 105_1, . . . , and 105_N) designed in the protocol layer view, and it is not needed for the Bluetooth radio circuits RF_0, RF_1, . . . , and RF_N to add additional circuit designs in a physical layer view.

In this embodiment, based on the synchronized clocks and the same configuration setting of the link control protocol sent from the host device 101 to set the Bluetooth controllers 105_0, 105_1, . . . , and 105_N as the central roles respectively in the protocol layer view, the packet transmission/reception times of the Bluetooth radio circuits RF_0, RF_1, . . . , and RF_N can be aligned with each other. This can effectively separate the packet transmission time of a Bluetooth radio circuit (e.g. RF_0) from the packet reception times of the other Bluetooth radio circuits RF_1, . . . , and RF_N.

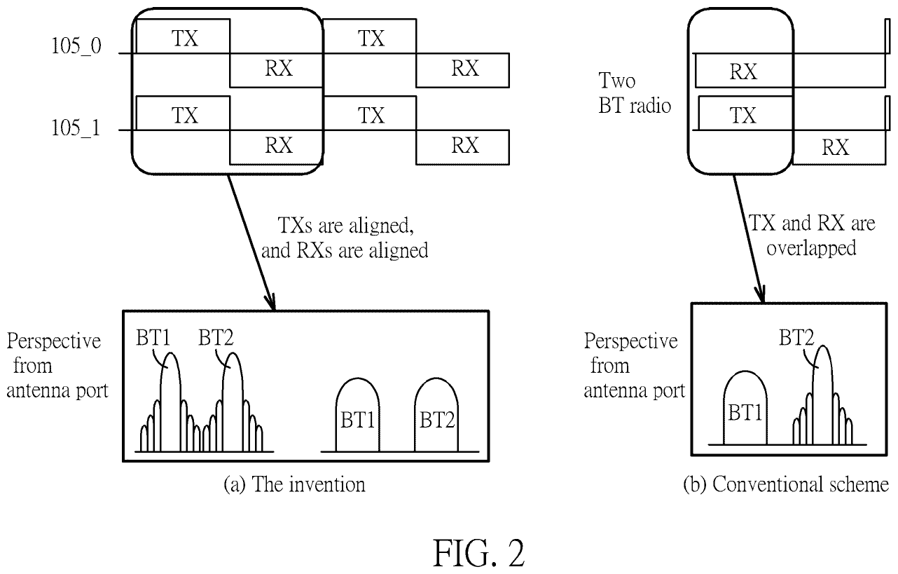

FIG. 2 is a diagram showing a concept example of two Bluetooth radio circuits' (e.g. RF_0 and RF_1) transmissions and receptions scheduled by the Bluetooth controllers 105_0 and 105_1 based on the disclosed multiple Bluetooth coexistence approach according to an embodiment of the invention. In the portion (a) of FIG. 2, based on the disclosed multiple Bluetooth coexistence approach, the two Bluetooth radio circuits (e.g. RF_0 and RF_1) may respectively transmit packets (or receive packets) at the same time. That is, the packet transmission times of the Bluetooth radio circuits (e.g. RF_0 and RF_1) are aligned, and also the packet reception times of the Bluetooth radio circuits (e.g. RF_0 and RF_1) are aligned. Since the packet transmission times can be separated from the packet reception times, no adjacent channel interference (ACI), i.e. a type of interference occurring in wireless communications when a signal from a nearby frequency channel disrupts the intended signal on the desired channel, can be introduced into the entire communication system. The entire communication system can more easily designed to mitigate the co-channel interference (CCI), i.e. a type of interference occurring in wireless communication systems when two or more transmitters use the same frequency channel, without considering the ACI effect.

In the portion (b) of FIG. 2, for conventional Bluetooth radio circuits, since the packet transmission time of a conventional Bluetooth radio circuit arranged by a conventional Bluetooth controller is overlapped with the packet reception time of another conventional Bluetooth radio circuit arranged by another conventional Bluetooth controller, thus from the perspective from antenna ports, the signal BT1 of the packet reception of a channel will be affected by adjacent channel interference (ACI) which is caused due to the packet transmission BT2 of an adjacent channel. The performance of the conventional scheme will be significantly degraded.

Further, in practice, in one embodiment, the multiple Bluetooth controllers comprise the first Bluetooth controller (e.g. 105_0) associated with the first Bluetooth radio circuit (e.g. RF_0) and the second Bluetooth controller 105_1 associated with the second Bluetooth radio circuit (e.g. RF_1). The time reference point used by the first Bluetooth controller 105_0 is synchronized with a time reference point used by the second Bluetooth controller 105_1 to schedule packet transmissions and packet receptions.

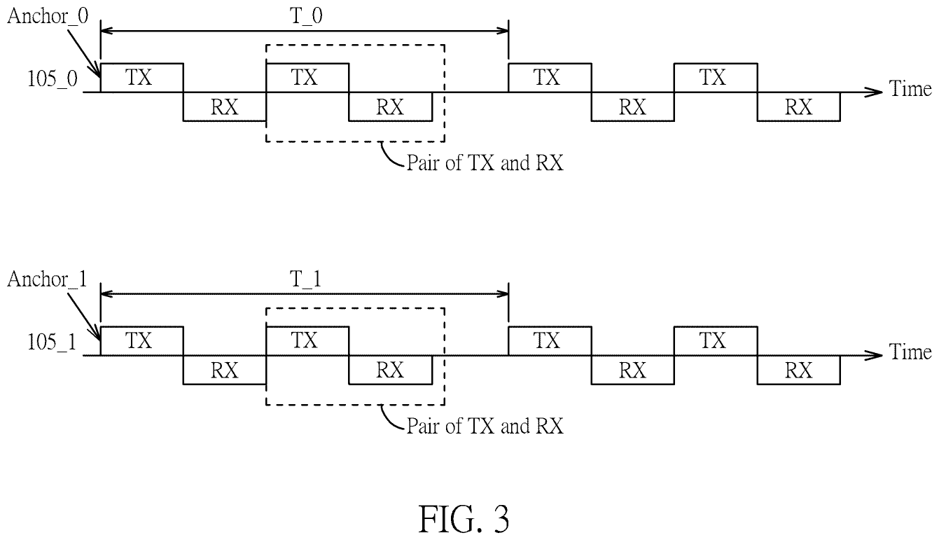

FIG. 3 is a diagram showing an example of synchronizing the time reference points respectively used by the Bluetooth controllers 105_0 and 105_1 according to an embodiment of the invention. In FIG. 3, the time reference points are anchor points (specific points in time) derived from the central/master Bluetooth controllers' 105_0 and 105_1 clocks that serve as absolute time references for all packet transmissions within the two piconets respectively. By doing so, the anchor point Anchor_0 employed by the first Bluetooth controller 105_0 is the same as the anchor point Anchor_1 employed by the second Bluetooth controller 105_1, and the time interval T_0 of first Bluetooth controller 105_0 can be identical to the time interval T_1 of second Bluetooth controller 105_1 if the two time intervals T_0 and T_1 are configured as the same time length. That is, the connection interval (e.g. T_0) of the link control protocol determined by the first Bluetooth controller (e.g. 105_0) is equal to connection interval (e.g. T_1) of the link control protocol determined by the second Bluetooth controller (e.g. 105_1). The Bluetooth controllers 105_0 and 105_1, both as central roles, are arranged to set or determine the connection intervals having the same time length.

In addition, in one embodiment, for example, the data packet length used by the first Bluetooth controller 105_0 is equal to a data packet length used by the second Bluetooth controller 105_1 for packet transmissions and packet receptions. For example, in FIG. 3, the data length of the packet transmission (TX) arranged and scheduled by the first Bluetooth controller 105_0 is configured to be identical to the data length of the packet transmission (TX) arranged and scheduled by the second Bluetooth controller 105_1. In addition, the data length of the packet reception (RX) arranged and scheduled by the first Bluetooth controller 105_0 is configured to be identical to the data length of the packet reception (RX) arranged and scheduled by the second Bluetooth controller 105_1. By doing so, when the anchor points Anchor_0 and Anchor_1 are the same, the data attributes (e.g. the data lengths of packet transmission (TX) and packet reception (RX)) are respectively identical for different Bluetooth controllers, and the orders of packet transmission (TX) and packet reception (RX) for the different Bluetooth controllers are arranged as the same, the packet transmission times of the Bluetooth controllers 105_0 and 105_1 can exactly happen at the same time, and also later the packet reception times of the Bluetooth controllers 105_0 and 105_1 can exactly happen at the same time. Thus, equivalently, the packet transmission time of Bluetooth controller 105_0 can be exactly separated from the packet reception time of Bluetooth controller 105_1, and also the packet reception time of Bluetooth controller 105_0 can be exactly separated from the packet transmission time of Bluetooth controller 105_1. ACI noise can be reduced.

In addition, for example, in another embodiment, the number of packet pairs determined by the first Bluetooth controller (e.g. 105_0) for a first peer Bluetooth controller is equal to a number of packet pairs determined by the second Bluetooth controller (e.g. 105_1) for a second peer Bluetooth controller. For example, in the time interval T_0, the number of packet pairs determined by the first Bluetooth controller 105_0 is equal to two, i.e. two pairs of packet transmission and reception. In the time interval T_1, the number of packet pairs determined by the second Bluetooth controller 105_1 is also equal to two, i.e. two pairs of packet transmission and reception. By doing so, when the anchor points Anchor_0 and Anchor_1 are the same, the data attributes (e.g. the data lengths of packet transmission (TX) and packet reception (RX)) are respectively identical for different Bluetooth controllers, the orders of packet transmission (TX) and packet reception (RX) for the different Bluetooth controllers are arranged as the same, and also the number of packet pairs are configured to be identical for the different Bluetooth controllers, the packet transmission times of the Bluetooth controllers 105_0 and 105_1 respectively during the whole time intervals T_0 and T_1 can more exactly happen at the same time, and also later the packet reception times of the Bluetooth controllers 105_0 and 105_1 respectively during the whole time intervals T_0 and T_1 can more exactly happen at the same time. Thus, equivalently, the packet transmission time of Bluetooth controller 105_0 during the whole time interval T_0 can be exactly separated from the packet reception time of Bluetooth controller 105_1 during the whole time interval T_1, and also the packet reception time of Bluetooth controller 105_0 during the whole time interval T_0 can be exactly separated from the packet transmission time of Bluetooth controller 105_1 during the whole time interval T_1. ACI noise can be reduced.

Further, in one embodiment, for example, the timing of a packet transmission (e.g. a beginning of a data packet) determined by the first Bluetooth controller (e.g. 105_0) is aligned with a timing of a packet transmission (e.g. a beginning of a data packet) determined by the second Bluetooth controller 105_1, and a timing of a packet reception determined by the first Bluetooth controller 105_0 is aligned with a timing of a packet reception determined by the second Bluetooth controller 105_1.

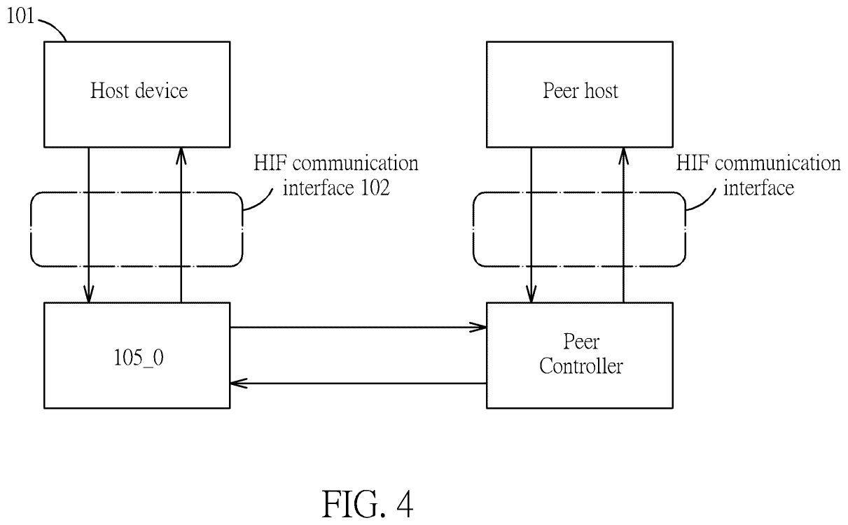

FIG. 4 is a diagram showing an example of the Bluetooth controller 105_0 (used as a central/master role) setting and negotiating parameter(s) of the link control protocol with a peer Bluetooth controller (used as a peripheral/slave role) according to an embodiment of the invention. The host device 101 sends a first configuration setting to the Bluetooth controller 105_0 through the HIF communication interface 102, and a peer host device may send a second configuration setting to the peer Bluetooth controller through another HIF communication interface. The first and second configuration settings may be different if the two Bluetooth controllers' types are different, and they may be identical if the two Bluetooth controllers' types are identical. The Bluetooth controller 105_0 based on the first configuration setting is arranged to compete to be used as a central role which is arranged to force at least one parameter of the link control protocol be configured as specified/default parameter(s). Similarly, if the Bluetooth controller 105_1 is also a central role and is arranged to force at least one parameter of the link control protocol be configured as specified/default parameter(s). That is, in this embodiment, the multiple Bluetooth controllers (e.g. 105_0 and 105_1) are used to force the at least one parameter of the link control protocol be identical based on the same first configuration setting.

For instance, the Bluetooth controllers (e.g. 105_0 and 105_1) are classic type Bluetooth controllers, and the at least one parameter may comprise at least one of a connection packet type, an automatic rate of a link manager protocol, a preferred data rate of the link manager protocol, a maximum number of time slots, a negotiation message of the link manager protocol, and a request packet type of the link manager protocol. For example (but not limited), the Bluetooth controllers (e.g. 105_0 and 105_1) may force the connection packet type as a single-slot packet type.

In this situation, for configuring the connection packet type as a single-slot packet type, in practice, the host device 101 is arranged to forbid the connection packet type being set as a multi-slot packet type by sending a specific instruction such as the HCI change connection packet type command to the Bluetooth controller 105_0 to tell the Bluetooth controller 105_0 what types of data packets the Bluetooth controller 105_0 can use for an active connection, e.g. selecting the single-slot packet type for an active connection. Then, the host device 101 may use and send the HCI create connection command to the Bluetooth controller 105_0 to initiate a connection with another Bluetooth device. Then, the Bluetooth controller 105_0 after booting up the firmware components(s) is arranged to execute the firmware components(s) to configure the default packet type as the single-slot packet type.

Then, the Bluetooth controller 105_0 used as the central role sends a command LMP_AUT_RATE, i.e. a specific link manager protocol (LMP) Protocol Data Unit (PDU) or message/command, into the peer Bluetooth controller that is coupled to the peer host device, to change the state of the CQDDR (Channel Quality Driven Data Rate) feature as the disabled state. That is, the Bluetooth controller 105_0 sends the command LMP_AUT_RATE to disable the CQDDR feature which is a feature of Classic (BR/EDR) Bluetooth system designed to optimize the connection and works by monitoring the quality of the radio-frequency signal. Once the peer Bluetooth controller accepts the command LMP_AUT_RATE, both the Bluetooth controllers update their internal state to “CQDDR disabled.” By doing so, the Bluetooth controller 105_0 used as the central role can turn off the automatic mechanism that allows the Bluetooth controller 105_0 and peer Bluetooth controller to dynamically change their data packet types based on the quality of the wireless link. Then, the Bluetooth controller 105_0 used as the central role may send a command LMP_PREFERRED_RATE, i.e. a specific link manager protocol (LMP) Protocol Data Unit (PDU) or message/command, into the peer Bluetooth controller that is coupled to the peer host device, to suggest/tell the peer Bluetooth controller the preference rate setting of the Bluetooth controller 105_0 in the disabled CQDDR state to adjust or influence the behavior when it is in the disabled CQDDR state. Then, the Bluetooth controller 105_0 used as the central role may send a pair of commands LMP_MAX_SLOT and LMP_MAX_SLOT_REQ, i.e. two commands within the link manager protocol that are used for managing the connection's data throughput, into the peer Bluetooth controller that is coupled to the peer host device, to negotiate the use of multi-slot (or single-slot) packets. The command LMP_MAX_SLOT sent by the Bluetooth controller 105_0 is used to inform the peer Bluetooth controller of the maximum number of slots which is permitted to use for a single packet transmission. In this embodiment, the Bluetooth controller 105_0 configures the command LMP_MAX_SLOT to indicate that the maximum number is up to one slot long to restrict to only single one slot. In addition, the command LMP_MAX_SLOT_REQ sent by the Bluetooth controller 105_0 into the peer Bluetooth controller is used to request a new maximum slot value. In this embodiment, the Bluetooth controller 105_0 configures the command LMP_MAX_SLOT_REQ to indicate that the new maximum number is up to one slot long to restrict to only single one slot. For the peer Bluetooth controller, the peer Bluetooth controller may send requests/commands LMP_AUT_RATE, LMP_PREFERRED_RATE, LMP_MAX_SLOT, LMP_MAX_SLOT_REQ, and LMP_PACKET_TYPE_TABLE_REQ to the Bluetooth controller 105_0 if role. they compete as the central/master The command LMP_PACKET_TYPE_TABLE_REQ is a command used in the Bluetooth link manager protocol by a Bluetooth controller device to propose switching the set of available packet types for an Asynchronous Connection-Less (ACL) link. In this situation, the Bluetooth controller 105_0 is arranged ignore or reject the to requests/commands sent from the corresponding peer Bluetooth controller, i.e. not accepting the requests/commands of the peer Bluetooth controller. Thus, after the negotiation mentioned above, the Bluetooth controller 105_0 smoothly acts as the central role and the peer Bluetooth controller acts as a corresponding peripheral role.

In one embodiments, if the requests/commands LMP_AUT_RATE, LMP_PREFERRED_RATE, LMP_MAX_SLOT, LMP_MAX_SLOT_REQ, and LMP_PACKET_TYPE_TABLE_REQ sent by the peer Bluetooth controller all restricted to the single-slot type, the Bluetooth controller 105_0 may be arranged to accept these requests/commands. That is, if the settings of the requests/commands sent by the peer Bluetooth controller are equal to the settings of the requests/commands sent by the Bluetooth controller 105_0, the Bluetooth controller 105_0 can accept these requests/commands.

Alternatively, in another embodiment, for instance (but not limited), the Bluetooth controllers (e.g. 105_0 and 105_1) are low energy type Bluetooth controllers (i.e. BLE (Bluetooth Low Energy) controllers), and the at least one parameter may comprise at least one of a connection packet type, a connection interval of a link layer control protocol (LLCP), a packet length of the link layer control protocol, a physical transmission rate of the link layer control protocol, and a number of packet pairs of transmissions and receptions of the link layer control protocol. Similarly, the Bluetooth controllers (e.g. 105_0 and 105_1) may force the connection packet type as a single-slot packet type.

In addition, for example, for configuring the fixed packet length, the host device 101 is arranged to set the same parameters for the multiple Bluetooth controllers 105_0, 105_1, . . . , and 105_N. In practice, the host device 101 the may send HCI_LE_Create_Connection command, i.e. an instruction in Bluetooth Low Energy (BLE) system used by a host device to tell its Bluetooth controller (the chip) to initiate a connection with a specific advertising peripheral device, into the Bluetooth controller such as 105_0. Then, the host device 101 may send the HCI_LE_Connection_Update command, i.e. an instruction in Bluetooth Low Energy (BLE) system that allows the host device 101 to request a change to the parameters of an existing connection, to the Bluetooth controller such as 105_0. After two BLE controller devices are already connected, the HCI_LE_Connection_Update command can be used to renegotiate the rules of their communications to optimize for lower power, higher throughput, or lower latency. Then, the host device 101 may send the HCI_LE_Remote_Connection_Parameter_Request_Reply command, i.e. a command sent by the host device 101 to its own Bluetooth controller such as 105_0. The HCI_LE_Remote_Connection_Parameter_Request_Reply command is used to accept a request from a connected peer device to change the connection parameters. Then, the host device 101 may send the HCI_LE_Set_Data_Length command, i.e. an instruction used by the host device 101 to request that the Bluetooth controller (e.g. 105_0) increase the maximum payload size of data packets for a specific and active connection, into the Bluetooth controller (e.g. 105_0). Then, the host device 101 may send the HCI_LE_Write_Suggested_Default_Data_Length command, i.e. an instruction used by the host device 101 to provide its Bluetooth controller (e.g. 105_0) with a set of default values for Data Length Extension (DLE) that it should attempt to use for all future BLE connections. Then, the host device 101 may send the HCI_LE_Extended_Create_Connection command, i.e. an instruction introduced in Bluetooth 5.0 system for creating a Bluetooth Low Energy connection, to the Bluetooth controller (e.g. 105_0). Then, the host device 101 may receive the HCI_LE_PHY_Update_Complete message/event from the Bluetooth controller (e.g. 105_0) which uses such event to report the final result of a physical layer change procedure back to the host device 101.

Then, for the side of Bluetooth controllers 105_0, 105_1, . . . , and 105_N, the Bluetooth controllers 105_0, 105_1, . . . , and 105_N after booting up the firmware components(s) are arranged to execute the firmware components(s) to configure their packet lengths as the default packet length according to the same parameters based on the above-mentioned commends received from the host device 101.

Then, for the LLCP communication of Bluetooth protocol stack, the Bluetooth controller 105_0 used as the central role for example may send the request LL_CONNECTION_PARAM_REQ, i.e. a formal request sent by the Bluetooth controller 105_0 to the peer Bluetooth controller over the air to negotiate a change in the connection parameters for an active link. The command LL_CONNECTION_PARAM_REQ in this example is restricted to an interval-only update. In addition, the Bluetooth controller 105_0 used as the central role for example may send the request LL_LENGTH_REQ, i.e. a specific message sent by the Bluetooth controller 105_0 to the peer Bluetooth controller over the air to initiate the Data Length Extension (DLE) negotiation. The setting of request LL_LENGTH_REQ is restricted to the default packet length. In addition, similarly, the Bluetooth controller 105_0 used as the central role for example may send the messages LL_LENGTH_RSP and LL_PYH_REQ into the peer Bluetooth controller. The Bluetooth controller 105_0 used as the central role for example may receive the requests/messages LL_CONNECTION_UPDATE_IND, LL_CONNECTION_PARAM_REQ, LL_CONNECTION_PARAM_RSP, LL_LENGTH_REQ, LL_LENGTH_RSP, LL_PHY_REQ, and LL_PYH_RSP sent from the peer Bluetooth controller. The message LL_LENGTH_RSP is a link layer control protocol data unit used in Bluetooth Low Energy system to serve as a mandatory response to a PDU LL_LENGTH_REQ during the Data Length Extension (DLE) negotiation procedure.

The message LL_PYH_REQ is a link layer control protocol data unit sent over the air from one Bluetooth controller to another Bluetooth controller to formally initiate the physical layer update procedure which allows the Bluetooth devices to dynamically switch between different physical layer modulations to optimize the connection for speed, range, or a balance of the speed and range. The message LL_PHY_RSP is a link layer control protocol data unit which is a response sent by a peripheral device (e.g. the peer Bluetooth controller) to the central device such as the Bluetooth controller 105_0 after receiving an LL_PHY_REQ_PDU.

The message LL_CONNECTION_UPDATE_IND is a link layer control protocol data unit which is a command sent from the central role to the peripheral role to command a change in the connection parameters. Thus, the Bluetooth controller 105_0 which competes as the central device is arranged or reject to ignore the message LL_CONNECTION_UPDATE_IND sent from the peer Bluetooth controller.

The message LL_CONNECTION_PARAM_REQ is a link layer control protocol data unit which is a formal request sent by one Bluetooth controller to a peer Bluetooth controller over the air to negotiate a change in the connection parameters for an active link. Similarly, the Bluetooth controller 105_0 as the central role can ignore or reject the message LL_CONNECTION_PARAM_REQ sent from the peer Bluetooth controller.

The message LL_CONNECTION_PARAM_RSP is a link layer control protocol data unit which is a response sent by a peripheral Bluetooth controller to a central Bluetooth controller after the peripheral Bluetooth controller receives a message LL_CONNECTION_PARAM_REQ. In this example, the Bluetooth controller 105_0 acting as the central role can accept the message LL_CONNECTION_PARAM_RSP sent from the peer Bluetooth controller.

The message LL_LENGTH_REQ is a link layer control protocol data unit which is used to start the negotiation for using larger data packets. Similarly, the Bluetooth controller 105_0 acting as the central role can ignore or reject the message LL_LENGTH_REQ sent from the peer Bluetooth controller, to maintain at the central role. The message LL_LENGTH_RSP is a link layer control protocol data unit which is a response to a message LL_LENGTH_REQ. The Bluetooth controller 105_0 acting as the central role can accept the reply message LL_LENGTH_RSP sent from the peer Bluetooth controller.

Similarly, the message LL_PYH_REQ is a link layer control protocol data unit sent over the air from one Bluetooth controller to another Bluetooth controller to formally initiate the physical layer update procedure which allows the Bluetooth devices to dynamically switch between different physical layer modulations to optimize the connection for speed, range, or a balance of the speed and range. The Bluetooth controller 105_0 acting as the central role can ignore or reject the message LL_PYH_REQ sent from the peer Bluetooth controller. The message LL_PHY_RSP is a link layer control protocol data unit which is a response sent by a peripheral device (e.g. the peer Bluetooth controller) to the central device such as the Bluetooth controller 105_0 after the peripheral device receives a message LL_PHY_REQ. Thus, the Bluetooth controller 105_0 acting as the central role can accept the message LL_PHY_RSP sent from the peer Bluetooth controller.

By doing so, the Bluetooth controller 105_0 acting as the central role is arranged to ignore or reject the request message sent from the peer Bluetooth controller so as to maintain its central role and may merely accept the reply message from peer Bluetooth controller.

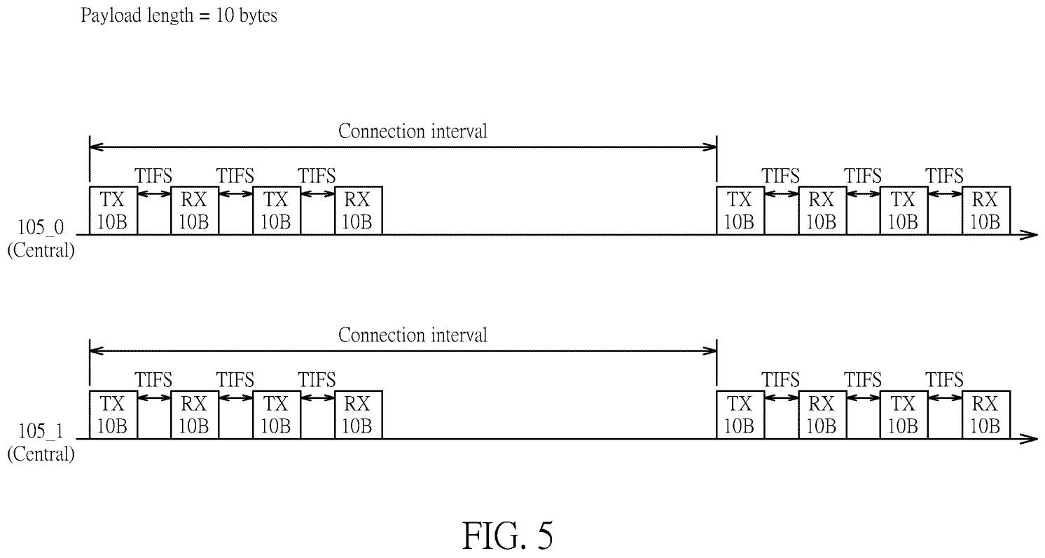

FIG. 5 is a diagram of the Bluetooth controllers such as 105_0 and 105_1 forcing the fixed payload length between the Bluetooth controllers 105_0 and 105_1 and their peer-side Bluetooth controllers as the same length according to an embodiment of the invention. In FIG. 5, the Bluetooth controllers 105_0 and 105_1 both acting as central roles for their peer Bluetooth controllers configures the payload length as the same length such as 10 bytes (indicated by ‘10 B’ in which the tailing ‘B’ indicate the unit of one byte) and can also force the payload length to be smaller than an upper boundary such as 18 bytes ('18 B′). Thus, based on the same parameters of the link layer protocol (i.e. the same payload length, the same length of connection intervals T_0 and T_1, the same order of the data transmission and reception, and the same start points of the connection intervals T_0 and T_1), during the connection intervals T_0 and T_1, the packet transmission times scheduled by the Bluetooth controller 105_0 can be exactly aligned with the packet transmission times scheduled by the Bluetooth controller 105_1, and the packet reception times scheduled by the Bluetooth controller 105_0 can be exactly aligned with the packet reception times scheduled by the Bluetooth controller 105_1.

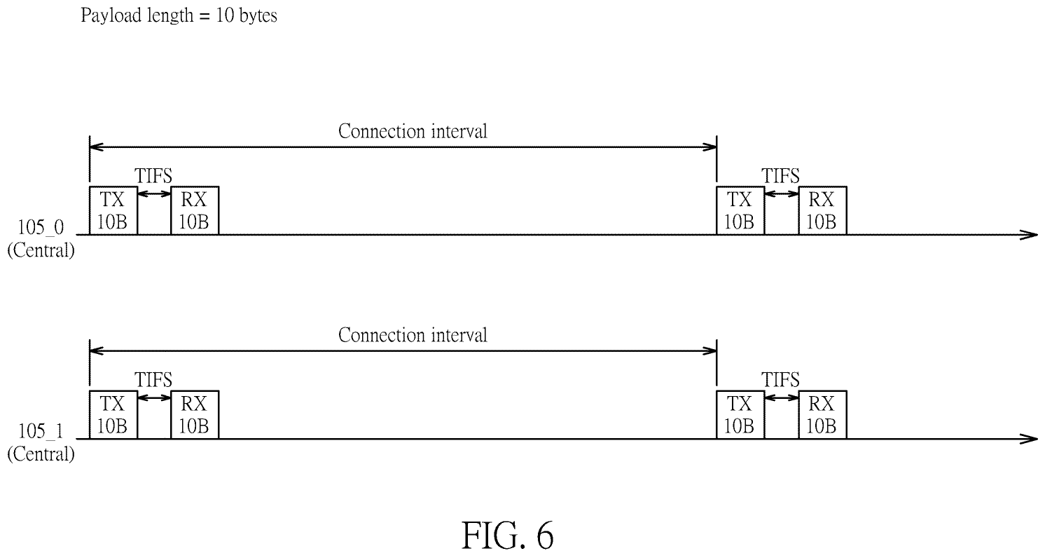

FIG. 6 is a diagram of the Bluetooth controllers such as 105_0 and 105_1 forcing the fixed payload length between the Bluetooth controllers 105_0 and 105_1 and their peer-side Bluetooth controllers as the same length and forcing only one pair of transmission and reception according to an embodiment of the invention. In FIG. 6, the Bluetooth controllers 105_0 and 105_1 both acting as central roles for their peer Bluetooth controllers configures the payload length as the same length such as 10 bytes (indicated by ‘10 B’ in which the tailing ‘B’ indicate the unit of one byte) and can also force the payload length to be smaller than an upper boundary such as 18 bytes ('18 B′) and also allowing only one pair of packet transmission and reception. Thus, based on the same parameters of the link layer protocol (i.e. only one pair of packet transmission and reception, the same payload length, the same length of connection intervals T_0 and T_1, the same order of the data transmission and reception, and the same start points of the connection intervals T_0 and T_1), during the connection intervals T_0 and T_1, the only one packet transmission time scheduled by the Bluetooth controller 105_0 can be exactly aligned with the only one packet transmission time scheduled by the Bluetooth controller 105_1, and the only one packet reception time scheduled by the Bluetooth controller 105_0 can be exactly aligned with the only one packet reception time scheduled by the Bluetooth controller 105_1.

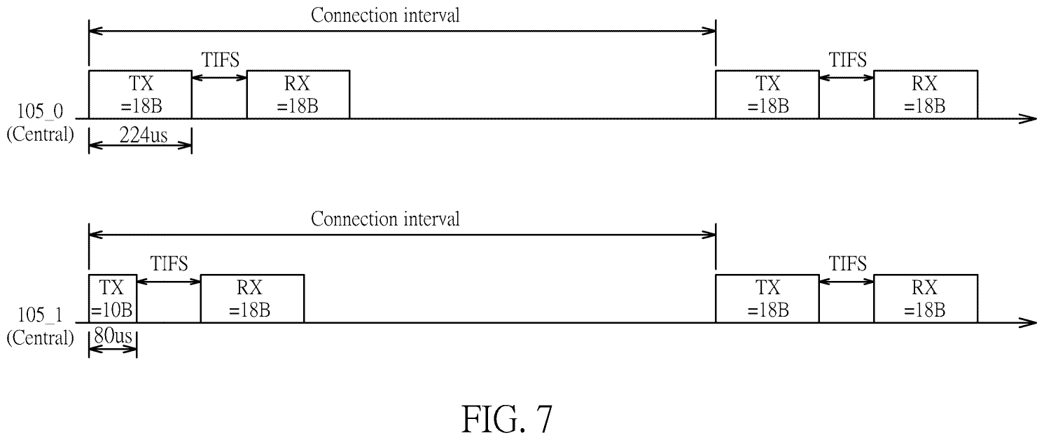

In the link layer control protocol, a maximum data length of a transmission packet is determined by the first Bluetooth controller to use an inter-frame spacing to separate a tailing portion of the transmission packet from a heading portion of a reception packet received by the second Bluetooth controller. FIG. 7 is a diagram of the Bluetooth controllers such as 105_0 and 105_1 forcing only one pair of transmission and reception (TRX) between the Bluetooth controllers 105_0 and 105_1 and their peer-side Bluetooth controllers and adjusting packet interval time lengths according to an embodiment of the invention. In FIG. 7, the Bluetooth controllers 105_0 and 105_1 both acting as central roles for their peer Bluetooth controllers configures their payload length as different lengths such as 18 bytes (indicated by ‘18 B’ in which the tailing ‘B’ indicate the unit of one byte) and 10 bytes (indicated by ‘10 B’) for the packet transmissions as shown in FIG. 1. For the packet receptions, the Bluetooth controllers 105_0 and 105_1 configures their payload lengths as identical length such as 18 bytes ('18 B′). The Bluetooth controllers 105_0 and 105_1 equivalently also force the payload length to be under the upper boundary such as 18 bytes ('18 B′) and also allowing only one pair of packet transmission and reception. The difference is that the packet transmission time in this example can be decreased appropriately by the Bluetooth controller (e.g. 105_1) to make a waiting period that a Bluetooth device must observe between receiving a packet and transmitting a packet, i.e. a time inter-frame space (TIFS), as a guard time to separate the packet transmission time of a Bluetooth controller (e.g. 105_0) from the packet reception time of another Bluetooth controller (e.g. 105_1).

Thus, based on the same parameters of the link layer protocol (i.e. only one pair of packet transmission and reception, the guard time TIFS, the same length of connection intervals T_0 and T_1, the same order of the data transmission and reception, and the same start points of the connection intervals T_0 and T_1), during the connection intervals T_0 and T_1, the only one packet transmission time scheduled by the Bluetooth controller 105_0 can be exactly aligned with the only one packet transmission time scheduled by the Bluetooth controller 105_1, and the only one packet reception time scheduled by the Bluetooth controller 105_0 can be exactly aligned with the only one packet reception time scheduled by the Bluetooth controller 105_1.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A Bluetooth controller device, coupled to a host device through a host interface function communication interface and coupled to multiple Bluetooth radio circuits, and the Bluetooth controller device comprises:
multiple Bluetooth controllers, for using a same configuration setting of a link control protocol sent from the host device to respectively control the multiple Bluetooth radio circuits to transmit and receive Bluetooth packets, clocks of the multiple Bluetooth controllers being synchronized with each other;
wherein the multiple Bluetooth controllers are used as central roles respectively to negotiate with corresponding peer Bluetooth controllers, to be used as peripheral roles associated with the central roles, by respectively ignoring or rejecting at least request from the corresponding peer Bluetooth controllers to make a packet transmission time of a first Bluetooth radio circuit in the multiple Bluetooth radio circuits be separated from a packet reception time of a second Bluetooth radio circuit in the multiple Bluetooth radio circuits.

2. The Bluetooth controller device of claim 1, wherein the multiple Bluetooth controllers comprises a first Bluetooth controller associated with the first Bluetooth radio circuit and a second Bluetooth controller associated with the second Bluetooth radio circuit; and, a time reference point used by the first Bluetooth controller is synchronized with a time reference point used by the second Bluetooth controller to schedule packet transmissions and packet receptions.

3. The Bluetooth controller device of claim 1, wherein the multiple Bluetooth controllers comprises a first Bluetooth controller associated with the first Bluetooth radio circuit and a second Bluetooth controller associated with the second Bluetooth radio circuit; and, a data packet length used by the first Bluetooth controller is equal to a data packet length used by the second Bluetooth controller for packet transmissions and packet receptions.

4. The Bluetooth controller device of claim 1, wherein the multiple Bluetooth controllers comprises a first Bluetooth controller associated with the first Bluetooth radio circuit and a second Bluetooth controller associated with the second Bluetooth radio circuit; and, a number of packet pairs determined by the first Bluetooth controller for a first peer Bluetooth controller is equal to a number of packet pairs determined by the second Bluetooth controller for a second peer Bluetooth controller.

5. The Bluetooth controller device of claim 1, wherein the multiple Bluetooth controllers comprises a first Bluetooth controller associated with the first Bluetooth radio circuit and a second Bluetooth controller associated with the second Bluetooth radio circuit; and, a connection interval of the link control protocol determined by the first Bluetooth controller is equal to connection interval of the link control protocol determined by the second Bluetooth controller.

6. The Bluetooth controller device of claim 1, wherein the multiple Bluetooth controllers comprises a first Bluetooth controller associated with the first Bluetooth radio circuit and a second Bluetooth controller associated with the second Bluetooth radio circuit; and, a timing of a packet transmission determined by the first Bluetooth controller is aligned with a timing of a packet transmission determined by the second Bluetooth controller, and a timing of a packet reception determined by the first Bluetooth controller is aligned with a timing of a packet reception determined by the second Bluetooth controller.

7. The Bluetooth controller device of claim 1, wherein the multiple Bluetooth controllers are used to force at least one parameter of the link control protocol be identical based on the same configuration setting; and, the at least one parameter comprises at least one of a connection packet type, an automatic rate of a link manager protocol, a preferred data rate of the link manager protocol, a maximum number of time slots, a negotiation message of the link manager protocol, and a request packet type of the link manager protocol.

8. The Bluetooth controller device of claim 1, wherein the multiple Bluetooth controllers are used to force at least one parameter of link control protocol be identical based on the same configuration setting; and, the at least one parameter comprises at least one of a connection packet type, a connection interval of a link layer control protocol, a packet length of the link layer control protocol, a physical transmission rate of the link layer control protocol, and a number of packet pairs of transmissions and receptions of the link layer control protocol.

9. The Bluetooth controller device of claim 1, wherein the multiple Bluetooth controllers comprises a first Bluetooth controller associated with the first Bluetooth radio circuit and a second Bluetooth controller associated with the second Bluetooth radio circuit; a single one packet pair determined by the first Bluetooth controller for a first peer Bluetooth controller is equal to a single one packet pair determined by the second Bluetooth controller for a second peer Bluetooth controller; and, in a link layer control protocol, a maximum data length of a transmission packet is determined by the first Bluetooth controller to use an inter-frame spacing to separate a tailing portion of the transmission packet from a heading portion of a reception packet received by the second Bluetooth controller.

10. A method of a Bluetooth controller device, the Bluetooth controller device to be coupled to a host device through a host interface function communication interface and coupled to multiple Bluetooth radio circuits, and the method comprises:
providing multiple Bluetooth controllers to use a same configuration setting of a link control protocol sent from the host device to respectively control the multiple Bluetooth radio circuits to transmit and receive Bluetooth packets, clocks of the multiple Bluetooth controllers being synchronized with each other; and
configuring the multiple Bluetooth controllers as central roles respectively to negotiate with corresponding peer Bluetooth controllers, to be used as peripheral roles associated with the central roles, by respectively ignoring or rejecting at least request from the corresponding peer Bluetooth controllers, to make a packet transmission time of a first Bluetooth radio circuit in the multiple Bluetooth radio circuits be separated from a packet reception time of a second Bluetooth radio circuit in the multiple Bluetooth radio circuits.

11. The method of claim 10, wherein the multiple Bluetooth controllers comprises a first Bluetooth controller associated with the first Bluetooth radio circuit and a second Bluetooth controller associated with the second Bluetooth radio circuit; and, a time reference point used by the first Bluetooth controller is synchronized with a time reference point used by the second Bluetooth controller to schedule packet transmissions and packet receptions.

12. The method of claim 10, wherein the multiple Bluetooth controllers comprises a first Bluetooth controller associated with the first Bluetooth radio circuit and a second Bluetooth controller associated with the second Bluetooth radio circuit; and, a data packet length used by the first Bluetooth controller is equal to a data packet length used by the second Bluetooth controller for packet transmissions and packet receptions.

13. The method of claim 10, wherein the multiple Bluetooth controllers comprises a first Bluetooth controller associated with the first Bluetooth radio circuit and a second Bluetooth controller associated with the second Bluetooth radio circuit; and, a number of packet pairs determined by the first Bluetooth controller for a first peer Bluetooth controller is equal to a number of packet pairs determined by the second Bluetooth controller for a second peer Bluetooth controller.

14. The method of claim 10, wherein the multiple Bluetooth controllers comprises a first Bluetooth controller associated with the first Bluetooth radio circuit and a second Bluetooth controller associated with the second Bluetooth radio circuit; and, a connection interval of the link control protocol determined by the first Bluetooth controller is equal to connection interval of the link control protocol determined by the second Bluetooth controller.

15. The method of claim 10, wherein the multiple Bluetooth controllers comprises a first Bluetooth controller associated with the first Bluetooth radio circuit and a second Bluetooth controller associated with the second Bluetooth radio circuit; and, a timing of a packet transmission determined by the first Bluetooth controller is aligned with a timing of a packet transmission determined by the second Bluetooth controller, and a timing of a packet reception determined by the first Bluetooth controller is aligned with a timing of a packet reception determined by the second Bluetooth controller.

16. The method of claim 10, further comprising:
forcing at least one parameter of the link control protocol be identical based on the same configuration setting;
wherein the at least one parameter comprises at least one of a connection packet type, an automatic rate of a link manager protocol, a preferred data rate of the link manager protocol, a maximum number of time slots, a negotiation message of the link manager protocol, and a request packet type of the link manager protocol.

17. The method of claim 10, further comprising:
forcing at least one parameter of the link control protocol be identical based on the same configuration setting;
wherein the at least one parameter comprises at least one of a connection packet type, a connection interval of a link layer control protocol, a packet length of the link layer control protocol, a physical transmission rate of the link layer control protocol, and a number of packet pairs of transmissions and receptions of the link layer control protocol.

18. The method of claim 10, wherein the multiple Bluetooth controllers comprises a first Bluetooth controller associated with the first Bluetooth radio circuit and a second Bluetooth controller associated with the second Bluetooth radio circuit; a single one packet pair determined by the first Bluetooth controller for a first peer Bluetooth controller is equal to a single one packet pair determined by the second Bluetooth controller for a second peer Bluetooth controller; and, in a link layer control protocol, a maximum data length of a transmission packet is determined by the first Bluetooth controller to use an inter-frame spacing to separate a tailing portion of the transmission packet from a heading portion of a reception packet received by the second Bluetooth controller.
